(19) United States
(12) Patent Application Publication
(10) Pub. No.: US 2013/0155223 A1
(43) Pub. Date: Jun. 20, 2013

(54) WARNING METHOD AND DEVICE

(71) Applicants: Shenq-Yuh JAW, Keelung City (TW); Wei-Chu WENG, Keelung City (TW)

(72) Inventors: Shenq-Yuh JAW, Keelung City (TW); Wei-Chu WENG, Keelung City (TW)

(73) Assignee: NATIONAL TAIWAN OCEAN UNIVERSITY, Keelung City (TW)

(21) Appl. No.: 13/546,320

(22) Filed: Jul. 11, 2012

(30) Foreign Application Priority Data
Dec. 20, 2011 (TW) 100147488

(51) Int. Cl. H04N 7/18

(52) U.S. Cl. 348/135; 348/E07.085

(57) ABSTRACT

A warning device includes a lighting unit, an image capturing unit and a processing unit. The lighting unit is configured for generating at least one light spot. The image capturing unit is configured for capturing and recording a series of images of the light spot in time sequence. The processing unit is coupled to the image capturing unit for analyzing a position of the light spot in each of the images, computing an overall displacement of the light spot according to the positions in the respective images, determining whether the overall displacement is greater than a predetermined safe value, and generating a warning output when the overall displacement is greater than the predetermined safe value.

### CROSS-REFERENCE TO RELATED APPLICATION

This application claims priority of Taiwanese Application No. 100147488, filed on Dec. 20, 2011.

### BACKGROUND OF THE INVENTION

1. Field of the Invention

The present invention relates to a warning device, more particularly to a warning device for warning occurrence of a disaster, a burglary, etc.

2. Description of the Related Art

Due to global climate change, natural disasters (for example, typhoon, torrential rain, etc.) are relatively violent and may cause mud-rock flow, landslide, floods, collapse of bridge piers, etc. Currently, the climate change can be monitored using satellites. However, it is hard to detect and forecast the mud-rock flow attributed to the torrential rain since an influence range of the mud-rock flow is extremely large and there are a lot of factors causing the mud-rock flow.

In addition, compared with typhoon and torrential rain, it is relatively difficult to forecast an earthquake since occurrence of an earthquake is sudden. Further, a conventional warning device for the earthquake is specially designed for detecting the earthquake and cannot detect other types of disasters.

### SUMMARY OF THE INVENTION

Therefore, an object of the present invention is to provide a warning device capable of forecasting and warning occurrence of various types of disasters, a burglary, etc.

Accordingly, a warning device of the present invention comprises a lighting unit, an image capturing unit and a processing unit. The lighting unit is configured for generating at least one light spot. The image capturing unit is configured for capturing and recording a series of images of the light spot in time sequence. The processing unit is coupled to the image capturing unit for analyzing a position of the light spot in each of the images, computing an overall displacement of the light spot according to the positions in the respective images, determining whether the overall displacement is greater than a predetermined safe value, and generating a warning output when the overall displacement is greater than the predetermined safe value.

Another object of the present invention is to provide a warning method of forecasting and warning occurrence of various types of disasters, a burglary, etc.

According to another aspect, a warning method of the present invention is to be implemented by a device including a lighting unit, an image capturing unit and a processing unit, and comprises the following steps of:

configuring the lighting unit to generate at least one light spot;

configuring the image capturing unit to capture and record a series of images of the light spot in time sequence;

configuring the processing unit to analyze a position of the light spot in each of the images, and to compute an overall displacement of the light spot according to the positions in the respective images;

configuring the processing unit to determine whether the overall displacement is greater than a predetermined safe value; and

configuring the processing unit to generate a warning output when the overall displacement is greater than the predetermined safe value.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a first preferred embodiment of a warning device for warning occurrence of a disaster according to this invention;

FIG. 2 is a block diagram of the warning device of the first preferred embodiment;

FIG. 3 is a flow chart of a warning method to be implemented using the warning device for warning occurrence of a disaster;

FIG. 4 is a schematic plot illustrating displacement of light spots on a screen of the warning device of the first preferred embodiment;

FIGS. 5 and 6 show distributions of cross-correlation functions for computing an overall displacement of the light spots on the screen;

FIG. 7 shows a Gaussian distribution relative to the cross-correlation functions for computing the overall displacement of the light spots in sub-pixel resolution;

FIG. 8 is a block diagram of a second preferred embodiment of a warning device according to this invention for warning occurrence of a disaster;

FIG. 9 is a schematic plot illustrating displacement of light spots on a screen of the warning device of the second preferred embodiment;

FIGS. 10 and 11 illustrate computation of the displacement of the light spots; and

FIG. 12 is a block diagram of a third preferred embodiment of a warning device according to this invention for warning occurrence of a burglary.

### DETAILED DESCRIPTION OF THE PREFERRED EMBODIMENTS

Before the present invention is described in greater detail, it should be noted that like elements are denoted by the same reference numerals throughout the disclosure.

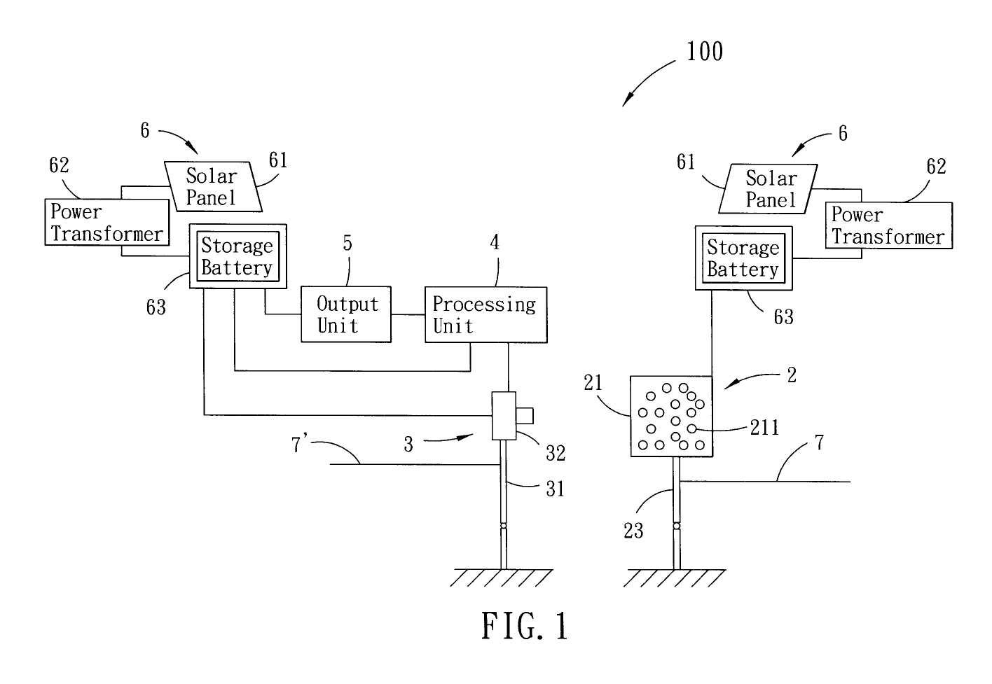

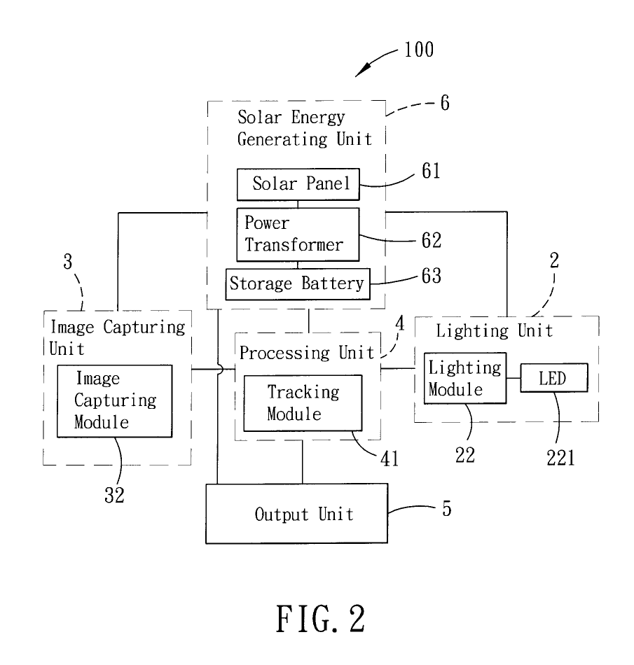

Referring to FIGS. 1 and 2, a first preferred embodiment of a warning device 100 of the present invention is for warning occurrence of a disaster, and includes a lighting unit 2, an image capturing unit 3, a processing unit 4 coupled to the image capturing unit 3, an output unit 5 coupled to the processing unit 4, and a solar energy generating unit 6.

The lighting unit 2 includes a first mounting member 23, a screen 21 mounted on the first mounting member 23, and a lighting module 22 disposed at the screen 21 for generating a plurality of light spots on the screen 21. In this embodiment, the screen 21 is black and is formed with a plurality of holes 211, and the lighting module 22 includes a plurality of light emitting diodes 221 disposed respectively within the holes 211 of the screen 21 so as to generate respective light spots. In particular, a number of the light spots (i.e., a number of the light emitting diodes 221) ranges from 15 to 20, and the light spots (i.e., the light emitting diodes 221) are arranged in a middle of the screen 21 and cover about half of the area of the screen 21. It should be noted that the number and the arrangement of the light spots are not limited to the disclosure of this embodiment.

The image capturing unit 3 includes a second mounting member 31, and an image capturing module 32 mounted on the second mounting member 31 and configured for capturing images of the light spots. A location of the second mounting member 31 is remote from a location of the first mounting member 23, for example, by 50 to 100 meters. In this embodiment, the image capturing module 32 is a charge-coupled device, and each of the first and second mounting members 23, 31 is a rod. In other embodiments, a plurality of the lighting units 2 may be disposed within a detection range of the image capturing module 32.

The solar energy generating unit 6 is coupled to the lighting unit 2, the image capturing unit 3, the processing unit 4 and the output unit 5 for providing electric power thereto. In this embodiment, the solar energy generating unit 6 includes a solar panel 61, a power transformer 62 coupled to the solar panel 61, and a storage battery 63 coupled to the power transformer 62. The solar panel 61 is configured for converting solar energy into direct current (DC) electricity, and the power transformer 62 is configured for transforming a voltage of the DC electricity from the solar panel 61 to a voltage suitable for charging the storage battery 63. Thus, the storage battery 63 is configured for storing the DC electricity from the power transformer 62 and for providing the electric power stored therein to the lighting unit 2, the image capturing unit 3, the processing unit 4 and the output unit 5.

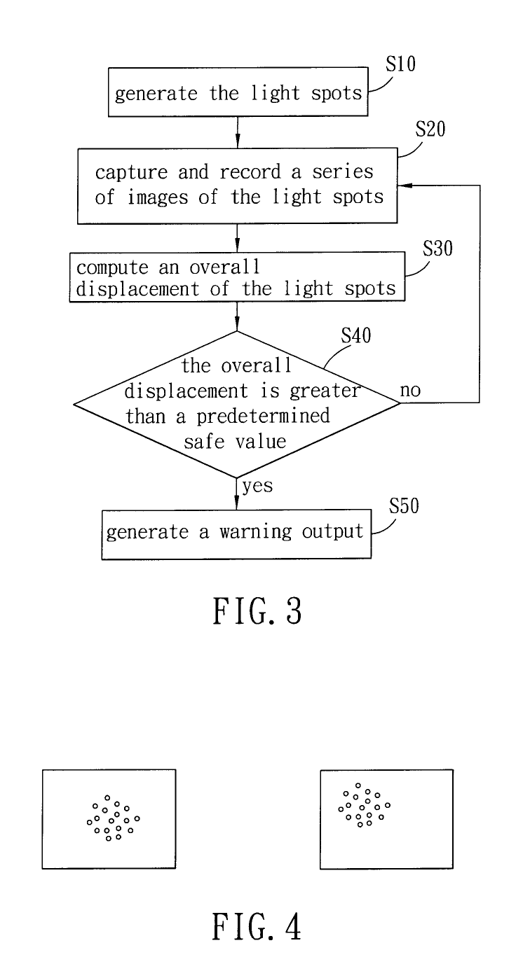

Further referring to FIG. 3, the warning device 100 is operable to implement a warning method including the following steps.

In step S10, the lighting unit 2 is operable to generate the light spots. Then, in step S20, the image capturing unit 3 is operable to capture and record a series of images of the light spots in time sequence as shown in FIG. 4. In particular, the image capturing unit 3 is operable to predetermine an interval time (e.g., 1 second) longer than a required time which the image capturing unit 3 requires for processing and recording an image, to capture an image of the light spots on the screen 21 of the lighting unit 2 at every interval time, and to record the image after filtering out background noise of the image. The image captured by the image capturing module 32 has a resolution of 2M×2N, that is to say, the image has a number (2M) of pixels in an x-axis and a number (2N) of pixels in a y-axis perpendicular to the x-axis. For example, if the detection range of the image capturing module 32 is 1280 (cm)×1280 (cm) and a resolution of the image is 1280 (pixel)×1280 (pixel), one pixel of the image actually covers an area of 1 cm². Further, the interval time predetermined by the image capturing unit 3 may be a floating time and is not limited to the disclosure of this embodiment.

In step S30, the processing unit 4 is operable to receive the images from the image capturing unit 3, and to compute an overall displacement of each of the light spots in the images. In particular, the processing unit 4 is operable to compute a displacement distance of each light spot in every temporally adjacent two of the images that are captured successively, and then, to compute a summation of the displacement distances as the overall displacement of the light spot. In other embodiments, the image capturing unit 3 may be configured to only record a first one of the images, and the processing unit 4 may be configured to compare a current one of other images with the first image and to compute a distance of each of the light spots between the current image and the first image as the overall displacement. Alternatively, both of the two computations for the overall displacement can be executed for accuracy.

In this embodiment, the processing unit 4 includes a tracking module 41. For every temporally adjacent two of the images that are captured successively, the tracking module 41 is operable to obtain a first function (f(i,j)) representing brightness values of respective pixels of an earlier one of the adjacent two images, and a second function (g(i,j)) representing brightness values of respective pixels of a later one of the adjacent two images, where i represents an i^{th} one of the pixels in the x-axis of the image and j represents a j^{th} one of the pixels in the y-axis of the image. Then, a cross-correlation function (C(m,n)) can be obtained based upon the first and second functions (f(i,j), g(i,j)) for the adjacent two images. The cross-correlation function (C(m,n)) can be expressed as Equation (1).

$${C}_{( m , n )} = \frac{{\sum }_{i = - M}^{M} {\sum }_{j = - N}^{N} f ( i , j ) g ( i - m , j - n )}{\sqrt{{\sum }_{i = - M}^{M} {\sum }_{j = - N}^{N} {f}^{2} ( i , j )} \sqrt{{\sum }_{i = - M}^{M} {\sum }_{j = - N}^{N} {g}^{2} ( i - m , j - n )}} \qquad ( 1 )$$

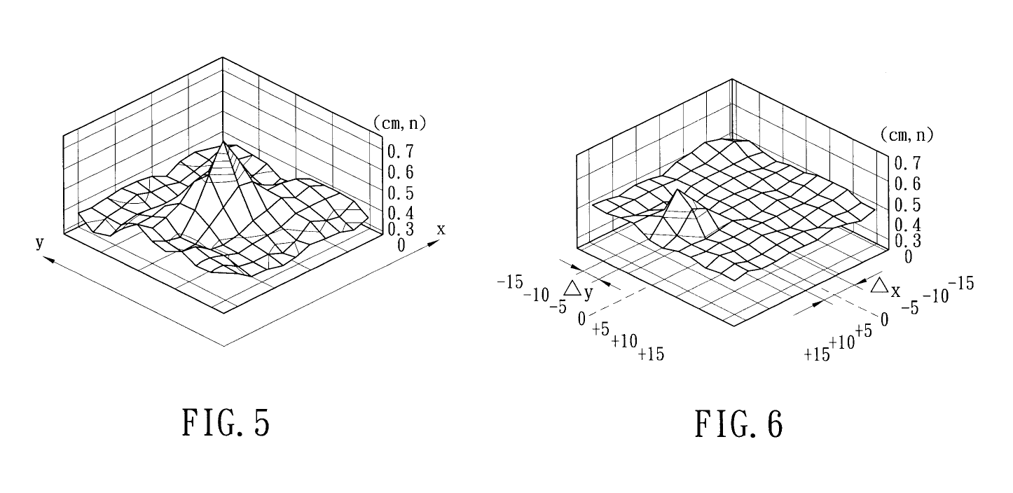

Then, as shown in FIGS. 5 and 6, the processing unit 4 is further operable to obtain a distribution of the cross-correlation function according to function values of the first and second functions (f(i,j), g(i,j)), i.e., the brightness values of the pixels of each of the adjacent two images. When a peak point of the distribution occurs at a coordinate (m,n), it means that a position of one of the light spots moves a number (m) of pixels in the x-axis and a number (n) of pixels in the y-axis between the adjacent two images. Namely, a distance between the peak point (m,n) and an origin point (0,0) is the displacement distance of the light spots between the adjacent two images.

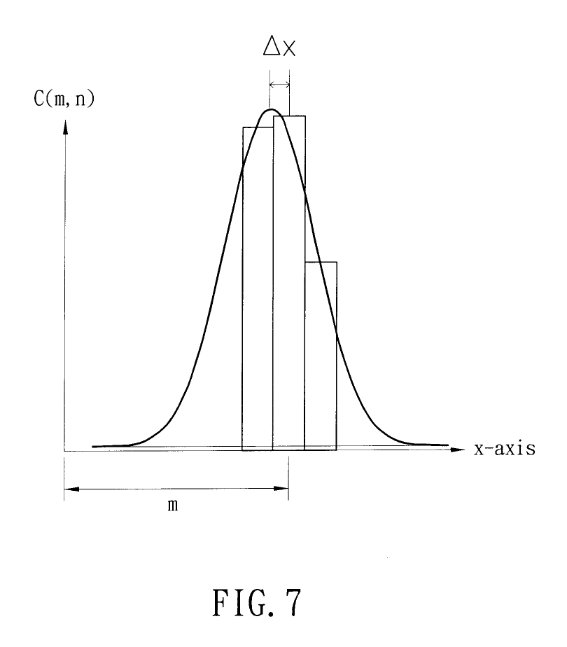

Further, in order to compute the displacement distance precisely, the tracking module 41 may be operable to smoothly link the peak point and adjacent points around the peak point so as to obtain a Gaussian distribution relative to the cross-correlation function as shown in FIG. 7. Then, the tracking module 41 is further operable to execute a sub-pixel analysis to compute a distance in sub-pixel resolution between a peak point of the Gaussian distribution and the peak point of the distribution of the cross-correlation function. In particular, when the distance between the peak point of the Gaussian distribution and the peak point (m,n) of the distribution of the cross-correlation function is Δx in the x-axis, the displacement distance of the light spots between the adjacent two images can be precisely computed as m+Δx in the x-axis. The distance Δx can be computed based upon

$$Δ x = \frac{ln ( {Z}_{m - 1} ) - ln ( {Z}_{m + 1} )}{2 [ ln ( {Z}_{m + 1} ) - 2 ln ( {Z}_{m} ) + ln ( {Z}_{m - 1} ) ]} , \qquad ( 2 )$$

where Zₘ is a function value of the cross-correlation function in the x-axis at the peak point (m,n). Similarly, the displacement distance of the light spots between the adjacent two images can be precisely computed as n+Δy in the y-axis, where Δy is the distance between the peak point of the Gaussian distribution and the peak point (m,n) of the distribution of the cross-correlation function in the y-axis and can be computed based upon an equation similar to Equation (2). Certainly, precision of the displacement distance is ½ pixel (i.e., 0.5 cm in this embodiment) before the sub-pixel analysis, and is about 1/10 to 1/100 pixel after the sub-pixel analysis.

In step S40, the processing unit 4 is operable to determine whether the overall displacement of any one of the light spots is greater than a predetermined safe value, for example, 2 pixels (i.e., 2 cm in this embodiment). In other embodiments, the predetermined safe value may be varied according to an area of a place where the warning device 100 is configured to perform detection. For example, the predetermined safe value may be relatively small when the warning device 100 is used to perform detection for a place where a disaster occurs and damages frequently. The flow goes to step S50 when the overall displacement is greater than the predetermined safe value, and goes back to step S20 when otherwise.

In step S50, the processing unit 4 is operable to generate a warning output and the output unit 5 is operable to output the warning output generated by the processing unit 4. For example, the output unit 5 may wirelessly transmit the warning output to a plurality of cell phones so as to warn a plurality of people far from the warning device 100. Moreover, the output unit 5 may also wiredly transmit the warning output to an alarm system so as to warn residents living around the warning device 100.

For a relatively broad place, such as a mountain, since it is impractical to dispose an adequate amount of the lighting units 2, the warning device 100 may further include a first linkage member 7 for connecting the first mounting member 23 with a remote location far from the first mounting member 23 such that the first linkage member 7 will move the first mounting member 23 and result in the overall displacement of the light spots on the screen 21 when a disaster (e.g., a mud-rock flow, earthquake, etc.) occurs at the remote location. Alternatively, the warning device 100 may further include a second linkage member 7′ for connecting the second mounting member 31 with a remote location far from the second mounting member 31, or include both of the first and second linkage members 7, 7′.

In other embodiments for detecting a flood or a groundwater level, the first mounting member 23 may be omitted and the screen 21 is mounted on a floating member floating on a water body, for example, a river or groundwater. When a level of the water body rises or drops, the light unit 2 rises or drops with the water body and the image capturing unit 3 captures an image with the light spots displacing from the last captured image. The processing unit 4 may be configured to compute the overall displacement of the light spots so as to measure the level of the water body. Thus, it is not required to read a water gauge so as to enhance accuracy of the measured level of the water body.

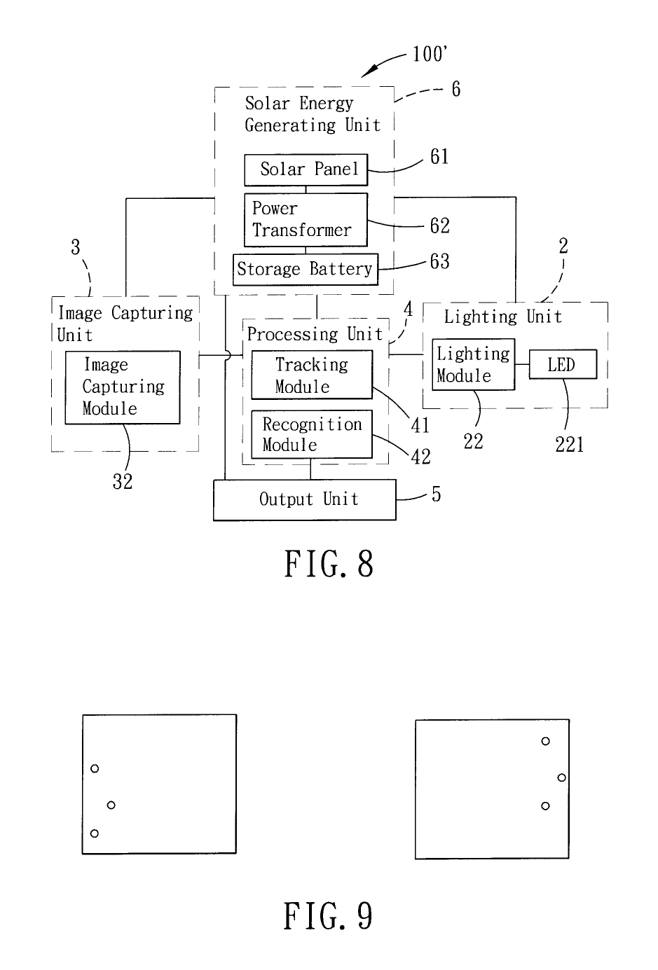

Referring to FIGS. 8 and 9, a second preferred embodiment of a warning device 100′ of this invention is shown to be similar to the first preferred embodiment. In this embodiment, the processing unit 4 further includes a recognition module 42 for dividing each of the images into a data portion where the light spots occur and a null-data portion without the light spots. Thus, the image capturing unit 3 only needs to filter out the background noise of the data portion such that the image capturing unit 3 requires relatively less time for processing the images.

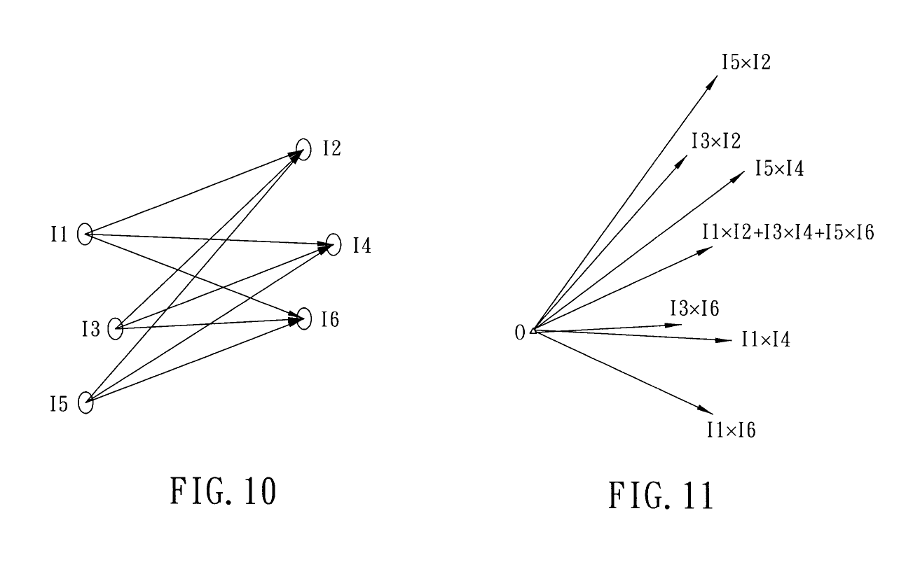

In particular, the recognition module 42 is operable to analyze each of the images and to recognize certain ones of the pixels of each of the images where the light spots occur so as to define said certain ones of pixels as the data portion and others of the pixels as the null-data portion. Then, the tracking module 41 is operable to obtain a first function (f(i,j)) representing brightness values of respective pixels of the light spots in an earlier one of the temporally adjacent two images, and a second function (g(i,j)) representing brightness values of respective pixels of the light spots in a later one of the temporally adjacent two images. In this embodiment, the processing unit 4 is operable, in step S30, to obtain a cross-correlation function in digital form based upon the first and second functions (f(i,j), g(i,j)) for the adjacent two images, and to compute a displacement vector of each of the light spots between the adjacent two images (see FIG. 10), that is to say, to compute a product of the brightness value of one of the light spots (I1, I3 and I5) and the brightness value of one of the light spots (I2, I4 and I6). In FIG. 10, (I1, I3 and I5) represent the light spots in the earlier one of the adjacent two images, (I2, I4 and I6) represent the light spots in the later one of the adjacent two images, and arrows represent possible displacement vectors of the light spots.

Then, the processing unit 4 is operable to obtain a distribution of the cross-correlation function similar to FIGS. 5 and 6 by superposing the products of the brightness values along all of the possible displacement vectors as shown in FIG. 11. In FIG. 11, (O) presents an origin point, and the displacement vectors from (I1) to (I2), from (I3) to (I4) and from (I5) to (I6) are parallel to one another so that these displacement vectors are superposed with one another.

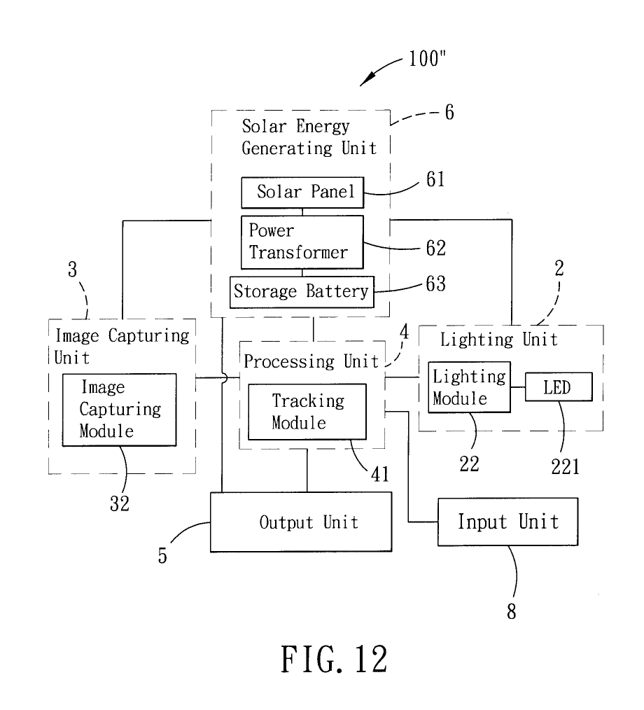

Referring to FIG. 12, a third preferred embodiment of a warning device 100″ of this invention is shown to be similar to the first preferred embodiment. In this embodiment, the warning device 100″ may be disposed at a front door and/or a window of a house for warning occurrence of a burglary. The lighting unit 2 is configured to generate only one light spot on the screen 21, and the warning device 100″ further includes an input unit 8 coupled to the processing unit 4 and user-operable to divide each of the images of the light spots into the data portion and the null-data portion. In this embodiment, the input unit 8 is a touch panel displaying the image of the light spot and allowing a user to input a user command to indicate the light spot on the image, and thus, the processing unit 4 is operable to divide the image into the data portion and the null-data portion according to the user command. As a result, when a burglar breaks into the house and moves the front door and/or the window, the image capturing unit 3 is operable to capture an image where the light spot has a displacement with respect to a last captured image, and the tracking module 41 is operable to rapidly compute the overall displacement of the light spot by using the direct cross-correlation function in the digital form. Then, the output unit 5 is operable to output an alarm and/or to send the warning output to a police station for asking for help.

To sum up, by virtue of the lighting unit 2, when a location (such as a mountain, a water body, a front door or a window of a house, etc.) where the lighting unit 2 is mounted has a displacement, the warning device 100, 100′, 100″ of this invention is operable to detect the displacement of the light spot(s) on the screen 21 of the lighting unit 2 so as to forecast and warn occurrence of a disaster (for example, a flood, a mud-rock flow, an earthquake, etc.) or a burglary. Further, the structure of the warning device 100, 100′, 100″ is relatively simple, and thus, manufacturing cost thereof is relatively low.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A warning device comprising:
a lighting unit for generating at least one light spot;
an image capturing unit for capturing and recording a series of images of the light spot in time sequence; and
a processing unit coupled to said image capturing unit for analyzing a position of the light spot in each of the images, computing an overall displacement of the light spot according to the positions in the respective images, determining whether the overall displacement is greater than a predetermined safe value, and generating a warning output when the overall displacement is greater than the predetermined safe value.

2. The warning device as claimed in claim 1, wherein the lighting unit includes a screen formed with a plurality of holes, and a lighting module disposed at said screen and configured for emitting light through said holes so as to generate a plurality of the light spots.

3. The warning device as claimed in claim 1, further comprising an output unit coupled to said processing unit for outputting the warning output generated by said processing unit.

4. The warning device as claimed in claim 1, wherein:
said lighting unit includes a first mounting member, a screen mounted at said first mounting member, and a lighting module disposed at said screen for generating the light spot on said screen; and
said image capturing unit includes a second mounting member, and an image capturing module mounted at said second mounting member and configured for capturing the images of the light spot.

5. The warning device as claimed in claim 4, further comprising a linkage member for connecting one of said first mounting member of said lighting unit and said second mounting member of said image capturing unit with a remote location far from said one of said first mounting member and said second mounting member.

6. The warning device as claimed in claim 1, further comprising a solar energy generating unit for providing electric power to at least one of said lighting unit, said image capturing unit and said processing unit.

7. The warning device as claimed in claim 1, wherein said processing unit includes a recognition module for dividing each of the images into a data portion where the light spot occurs and a null-data portion without the light spot, and recognizing the light spot in the data portion.

8. The warning device as claimed in claim 1, wherein said processing unit includes a tracking module for:
obtaining a plurality of functions each of which represents pixels of a respective one of the images;
obtaining a plurality of cross-correlation functions each of which is based upon two of the functions associated respectively with temporally adjacent two of the images that are captured successively, and respective distributions of the cross-correlation functions; and
computing the overall displacement of the light spot according to a distance between a peak point and an origin point of each of the distributions.

9. The warning device as claimed in claim 8, wherein said tracking module is further configured for obtaining a Gaussian distribution relative to a respective one of the cross-correlation functions, and for executing a sub-pixel analysis to compute the overall displacement of the light spot according to a distance in sub-pixel resolution between a peak point of the Gaussian distribution and the peak point of the distribution of said respective one of the cross-correlation functions.

10. The warning device as claimed in claim 1, wherein said processing unit is configured for computing a displacement distance of the light spot in every temporally adjacent two of the images that are captured successively, and for computing a summation of the displacement distances as the overall displacement of the light spot.

11. The warning device as claimed in claim 1, wherein said processing unit is configured for analyzing and comparing the position of the light spot in a first one of the images with the position of the light spot in each of the others of the images so as to obtain the overall displacement of the light spot.

12. The warning device as claimed in claim 1, wherein said processing unit further includes a tracking module for:
obtaining a plurality of functions each of which represents pixels of the light spot in a respective one of the images;
obtaining a plurality of direct cross-correlation functions in digital form, each of the direct cross-correlation functions being obtained based upon two of the functions associated respectively with temporally adjacent two of the images that are captured successively;
obtaining respective distributions of the direct cross-correlation functions; and
computing the overall displacement of the light spot according to a distance between a peak point and an origin point of each of the distributions.

13. The warning device as claimed in claim 12, wherein said tracking module is further configured for obtaining a Gaussian distribution relative to the direct cross-correlation functions, and for executing a sub-pixel analysis to compute the overall displacement of the light spot according to a distance in sub-pixel resolution between a peak point of the Gaussian distribution and the peak point of each of the distributions of the direct cross-correlation functions.

14. A warning method to be implemented by a device including a lighting unit, an image capturing unit and a processing unit, said method comprising the following steps of:
a) configuring the lighting unit to generate at least one light spot;
b) configuring the image capturing unit to capture and record a series of images of the light spot in time sequence;
c) configuring the processing unit to analyze a position of the light spot in each of the images, and to compute an overall displacement of the light spot according to the positions in the respective images;
d) configuring the processing unit to determine whether the overall displacement is greater than a predetermined safe value; and
e) configuring the processing unit to generate a warning output when the overall displacement is greater than the predetermined safe value.

15. The warning method as claimed in claim 14, wherein step b) includes the following sub-steps of:
b1) configuring the image capturing unit to capture an image of the light spot at every interval time; and
b2) configuring the image capturing unit to record the image after filtering out background noise of the image.

16. The warning method as claimed in claim 14, wherein step c) includes the following sub-steps of:
c1) configuring the processing unit to obtain a plurality of functions each of which represents pixels of a respective one of the images;
c2) configuring the processing unit to obtain a plurality of cross-correlation functions each of which is based upon two of the functions associated respectively with temporally adjacent two of the images that are captured successively, and respective distributions of the cross-correlation functions; and
c3) configuring the processing unit to compute the overall displacement of the light spot according to a distance between a peak point and an origin point of each of the distributions.

17. The warning method as claimed in claim 14, wherein step c) includes the following sub-steps of:
c1) configuring the processing unit to obtain a plurality of functions each of which represents pixels of the light spot in a respective one of the images;
c2) configuring the processing unit to obtain a plurality of direct cross-correlation functions in digital form, each of the direct cross-correlation functions being obtained based upon two of the functions associated respectively with temporally adjacent two of the images that are captured successively;
c3) configuring the processing unit to obtain respective distributions of the direct cross-correlation functions; and
c4) configuring the processing unit to compute the overall displacement of the light spot according to a distance between a peak point and an origin point of each of the distributions.

18. The warning method as claimed in claim 14, wherein, in step c), the processing unit is configured for computing a displacement distance of the light spot in every temporally adjacent two of the images that are captured successively, and for computing a summation of the displacement distances as the overall displacement of the light spot.

19. The warning method as claimed in claim 14, wherein, in step c), the processing unit is configured for analyzing and comparing the position of the light spot in a first one of the images with the position of the light spot in each of the others of the images so as to obtain the overall displacement of the light spot.
